(19) United States
(12) Patent Application Publication
(10) Pub. No.: US 2012/0124037 A1
(43) Pub. Date: May 17, 2012

(54) MULTIMEDIA DATA SEARCHING METHOD AND APPARATUS AND PATTERN RECOGNITION METHOD

(75) Inventors: Yong Jin LEE, Ansan (KR); Han Sung Lee, Yongin (KR); So Hee Park, Daejeon (KR); Yun Su Chung, Daejeon (KR)

(73) Assignee: Electronics and Telecommunications Research Institute, Daejeon (KR)

(21) Appl. No.: 13/196,646

(22) Filed: Aug. 2, 2011

(30) Foreign Application Priority Data
Nov. 17, 2010 (KR) 10-2010-0114368

(51) Int. Cl. G06F 17/30; G06F 15/18

(52) U.S. Cl. 707/723; 706/12; 707/E17.084

(57) ABSTRACT

The present invention relates to multimedia search method and apparatus, and a pattern recognition method. The multimedia search method according to an exemplary embodiment of the present invention includes: searching for data corresponding to search condition data input by a user in search target data; selecting training data for machine learning on the basis of the search result; performing machine learning by using the selected training data; and modifying the search result by using the result of the machine learning.

### CROSS-REFERENCE TO RELATED APPLICATIONS

This application claims priority under 35 U.S.C. §119 to Korean Patent Application No. 10-2010-0114368, filed on Nov. 17, 2010 in the Korean Intellectual Property Office, the disclosure of which is incorporated herein by reference in its entirety.

### TECHNICAL FIELD

The present invention relates to multimedia data search method and apparatus, and a pattern recognition method, and more particularly, to multimedia data search method and apparatus, and a pattern recognition method for improving the accuracy of search with low computational complexity.

### BACKGROUND

With the development of computers, a user increasingly demands high level services with various multimedia data. For example, until recently, in order to enjoy clear and live audio, efficient and fast compression and decompression technique has been a main issue. However, currently, a user wants ‘query by humming service’, which involves taking a user-hummed melody (search condition data) and comparing it to an existing database and the system then returns a ranked list of music closest to the user input. For another example, a user had been satisfied that he manually stores and manages photos of family members and friends on digital albums and browses them on a computer. However, currently, a user demands services or computer programs that recognize and classify faces of persons and organize photo albums automatically.

Moreover, as people personally produce and distribute various digital multimedia data through the Internet, services for searching a large amount of multimedia data is gradually demanded and increasing.

However, because of the characteristics of multimedia data, it is difficult to implement a pattern recognition system with high recognition performance or a search system with high precision, recall or rank-N performance. For example, humans can easily recognize and determine whether two different face photos are from the same person or different persons. However, it is difficult to explicitly define rules and write codes which can recognize and classify human faces.

For this reason, most of pattern recognizing systems including multimedia data search systems employs a statistical data analysis or machine learning method. Instead of defining explicit rules manually, feature extraction/classification/comparison/recognition methods, etc., are implicitly defined by collecting and analyzing example data. This process is known as ‘statistical data analysis’ or ‘machine learning’ or simply as ‘learning’ or ‘training’. Example data used for the statistical data analysis or machine learning is referred to as training data. In the case of a data search system, a dataset, which is stored in database and compared with search condition data input by a user, is used as training data.

More specifically, a general pattern recognition system including a multimedia data search system implements (or trains) a classifier or a feature extractor with training data. Further, the pattern recognition system performs feature extraction, classification, and/or recognition of features, etc., by applying learning (training) results to test data (which includes data that are not used as training data (unseen data) or data input by a search system user to describe a user's intention (search condition data, query)). Here, examples of representative classifiers or classification methods include an SVM (support vector machine), and examples of feature extractors or feature extraction methods include PCA (principal component analysis). The results of classification or extracted features may be used further for a higher level of image recognition, multimedia data search, etc., and such process can be also considered as application of learning.

Most machine learning methodologies employed by pattern recognition systems including multimedia search systems assume that training data can approximate test data accurately or has a similar statistical property to test data. And, as the assumption is better satisfied, better recognition/classification/search performance can be expected when learning results (such as trained classifiers or feature extractors) are applied in real fields. That is, in order to implement a system with high recognition/classification/search performance through the machine learning, not only methodology of the machine learning (or algorithm) but also training data should be carefully selected. However, in practice it is difficult to collect training data that have similar or represent the statistical properties of test data at an implementation or design stage of search systems before implemented systems are deployed in real fields and test data are actually given by a user. In general, training data and test data have different statistical properties from each other since the time and environment when/where data are acquired are different. Even though a large amount of data is collected and used as the training data in order to cope with various situations, it may not get all-around learning results for various situations since there are many different cases with different inherent complex factors and therefore learning methods or algorithms may not catch what system designers or developers imply through data. In other words, ‘more data’ does not necessary mean ‘better performance’. Furthermore, when the individual size and the number of data is large as in a collection of multimedia data such as images, audio, or video, data analysis or learning (training) itself is extremely difficult due to time and memory limits of computers.

In some cases, in order to process a large amount of data computationally efficiently, relatively simple and explicit rules, which a system designer manually defines without resort to machine learning methods, are used for feature extraction. However, in most cases, it is still very difficult that a system designer manually selects and combines the features to further improve the performance of search or recognition systems.

Therefore, in general features are extracted in two steps. At the first step, primary features are extracted by simple and explicit rules defined manually without resort to machine learning methods. This may be called ‘preprocessing’. At the second step, secondary features are extracted from the primary features by statistical data analysis or machine learning methods so as to be used. Also, it is possible to perform recognition/comparison/classification by using a classifier trained with the primary or secondary features.

In most multimedia data search systems, original data, which primary features are extracted from, and primary features are high dimensional data. In addition, the size of a dataset (search space) demanded by users are huge and increasing exponentially. Furthermore, for accurate data analysis or learning, computer memories are required more than the size of data (or training data) itself. Also, computational complexity increases more than linearly as the dimensions or amount of data increase. Therefore, even though feature extraction/classification/comparison/recognition methods for accurate search are developed, in practice it is not easy to apply them to multimedia search systems. Therefore, for efficient and fast computation, at the cost of accuracy, simplified statistical data analysis methods or machine learning methods are used in a multimedia search system.

To resolve computational burdens in machine learning, learning methods based on Nystrom approximation have been attempted. The methods select a subset of training data. The selected data is referred as to landmark data and the landmark data is used as actual training data. However, there are still other difficult issues ‘which data we should select among the entire data as landmark data’ and ‘how to select.’ Furthermore, depending on selected data or selection methods, the performance of recognition or search would be inferior than using the entire dataset as training data.

### SUMMARY

An exemplary embodiment of the present invention provides a pattern recognition method comprising: selecting a subset of training data on the basis of test data; performing machine learning by using the selected training data; and applying the result of the machine learning to the test data.

Another exemplary embodiment of the present invention provides a multimedia data search method including: searching for data corresponding to search condition data input by a user in search target data; selecting training data for machine learning on the basis of the search result; performing machine learning by using the selected training data; and modifying the search result by using the result of the machine learning.

Yet another exemplary embodiment of the present invention provides multimedia data search apparatus including: a database storing a search dataset and primary search dataset features extracted from the search dataset; a first search unit extracting primary search condition feature from search condition data input by a user and searching for data corresponding to the primary search condition feature in the database by comparing the primary search dataset features with the primary search condition feature; a performing unit selecting training data for machine learning on the basis of the search result and performing machine learning by using the selected training data; and a second search unit modifying the search result by using the result of the machine learning.

Still another exemplary embodiment of the present invention provides a data search apparatus including: a selecting unit selecting a subset of a search dataset as training data on the basis of search condition data; a performing unit performing machine learning by using the selected training data; and a search unit searching for data corresponding to the search condition data from the search target data by using the result of the machine learning.

Other features and aspects will be apparent from the following detailed description, the drawings, and the claims.

### BRIEF DESCRIPTION OF THE DRAWINGS

FIG. 1A is a conceptual view illustrating a pattern recognition method according to an exemplary embodiment of the present invention;

FIG. 1B is a conceptual view illustrating a multimedia search method according to an exemplary embodiment of the present invention;

FIG. 2 is a block diagram illustrating a multimedia search apparatus according to another exemplary embodiment of the present invention;

FIG. 3 is a conceptual view illustrating a multimedia search method according to another exemplary embodiment of the present invention;

FIG. 4 is a conceptual view illustrating a multimedia search method according to another exemplary embodiment of the present invention; and

FIG. 5 is a conceptual view illustrating a multimedia search method according to another exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

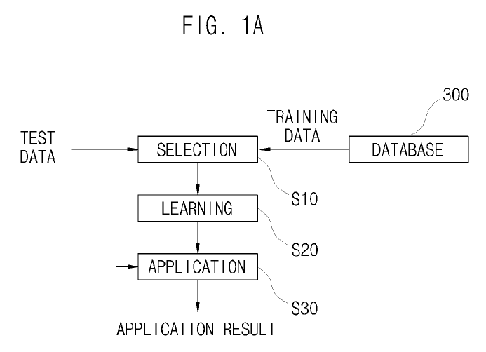

First, a pattern recognition method according to an exemplary embodiment of the present invention will be described with reference to FIG. 1A. FIG. 1A is a conceptual view illustrating a pattern recognition method according to an exemplary embodiment of the present invention.

Referring to FIG. 1A, a pattern recognition method according to an exemplary embodiment includes a selecting step (S10), a learning step (S20), and an applying step (S30).

First, the selecting step (S10) selects a subset of training data on the basis of test data. The training data may be stored in a database 300. For example, the selecting step (S10) may select data which can approximate the test data accurately or estimate a class of the test data well, or data having a statistical property similar to that of the test data from the training data. Here, the similar data may mean data being in a predetermined range from the statistical property of the test data, and the predetermined range may be set or changed by a user.

Next, the learning step (S20) performs machine learning by using the selected training data. Then, the applying step (S30) performs extraction or classification, or recognition or others of the features of the test data by using the learning result.

In a pattern recognition method based on machine learning according to the related art, a learning process and a learning application process are clearly separate. That is, training data is collected independently from test data and thus training data may be unrelated to test data. Further, since the learning result is applied to different test data without considering the properties of individual test data, the learning result may have little relation to some test data and overall recognition performance would be poor. However, in this exemplary embodiment, since a subset of the training data is selected on the basis of the test data and is used as actual training data, even when any test data is given, it is possible to expect better performance in recognition, classification, etc., and to effectively apply machine learning with respect to a large amount of data.

Hereinafter, specific exemplary embodiments to which the spirit or scope of the present invention described above with reference to FIG. 1A is applied will be described.

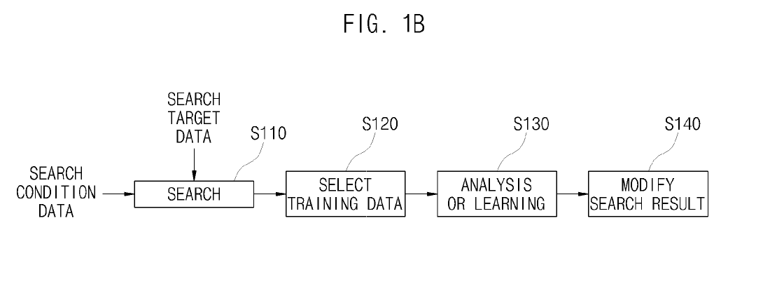

First, a multimedia data search method and apparatus according to exemplary embodiments of the present invention will be described with reference to FIGS. 1B and 2. FIG. 1B is a conceptual view illustrating a multimedia search method according to an exemplary embodiment of the present invention, and FIG. 2 is a block diagram illustrating a multimedia search apparatus according to another exemplary embodiment of the present invention.

Referring to FIGS. 1B and 2, a multimedia search apparatus 20 according to an exemplary embodiment of the present invention includes a first search unit 200, a performing unit 400, a second search unit 500, and a database 300.

First, if a user inputs search condition data, the first search unit 200 searches for data corresponding to the test data in a search dataset stored in the database 300 (S110). Here, the search condition data means a query, a search conditional expression, or search example data that the user inputs for a desired search, and the search dataset may mean data registered or stored in the database 300. The search condition data corresponds to the test data of FIG. 1A and the search dataset corresponds to the training data of FIG. 1A.

The first search unit 200 may compare search condition data with a search dataset stored in the database 300 and rank data of a search dataset from the most similar one to the least similar one and output a ranked list as the search result. For example, if search condition data such as a photo of a person's face is input, the first search unit 200 may compare the face input by user and faces stored in the database 300 and rank face photos stored in a database 300 from a most similar face image to a least similar face image and output ranked face images as the search result.

Meanwhile, the search and comparing method of the first search unit 200 may be one of well-known search methods used in existing established search systems, and is not limited to a specific method or specific search data.

Next, the performing unit 400 selects training data for statistic analysis or machine learning from the search dataset stored in the database 300 on the basis of the search result of the first search unit 200 (S120), and performs machine learning with the selected training data (S130). For example, the performing unit 400 may select data which are determined to have the closet correspondence to the demand of the user and are ranked in the top in the search result of the first search unit 200, as data for analysis or training data (hereinafter, referred to as ‘training data’). The major reasons why the top ranking data are chosen as the training data may be two.

First, the top ranking data can be regarded that they have the highest similarity with the search condition data, and most accurately approximate the search condition data or have a statistical property similar to that of the search condition data. Therefore, by using the top ranking data as the training data, it is possible to obtain more optimized learning result. This can be considered as suggesting an answer to the questions ‘which data should we select from the entire data as landmark data?’ and ‘how?’ from Nystrom approximation based learning. However, the conventional approach based on the Nystrom approximation still separate the learning step and the learning application step as any other conventional machine learning methods; it is difficult to compose optimal training data with respect to test data.

As described above, one of the major assumptions of the machine learning is that the training data (at least a subset of the search dataset in this exemplary embodiment) can approximate the search condition data well, which is not used in an analysis/learning step, or has a similar statistical feature to the search condition data. And, as the assumption is better satisfied, better recognition/classification/search performance can be expected when learning results (such as trained classifiers or feature extractors) are applied to test data (search condition data) in real fields. In this respect, it can be considered that this exemplary embodiment suggests the method for composing optimal training data on the basis of the search condition data in order to implement a system having higher recognition/classification/search performance.

Second, the top ranking data are likely to be in a class boundary (which is referred to in a classification or classifier theory for the machine learning) or in the vicinity thereof. The class boundary is a place where data belonging to different classes lie close to each other in a data space. Since the top ranking data and the condition search data are similar to each other, they all may belong to the same class; then, problems are solved since we have found data from a search dataset which belong to the same class with search condition data. Otherwise, it is likely that the top ranking data lie in the class boundary around the search condition data. According to the classification or classifier theory in the machine learning, data in the class boundary has the most significant effect on the learning result and it is possible to generate a sufficiently good classifier with only a small amount of data in the class boundary rather than simply a large amount of training data. Therefore, a good classifier can be trained with a small amount of top ranking data instead of the entire search target data while minimizing the memory and the computational cost for analysis/learning.

Meanwhile, the performing unit 400 may select a predetermined number of data from the upper rank to a lower rank; however, it may also adaptively select the data by using a primary search result.

An example of this is as follows. The multimedia search apparatus may directly and/or indirectly compare the data stored in the database 300 of the search system with the search condition data input by the user and generate the degrees of correspondence, that is, similarity values. Two cases shows different score patterns; when a relevant data is ranked in the top and when a non-relevant data is ranked in the top. A relevant data means what a user actually wants to search for. The patterns of the different cases are better discriminated particularly when

This phenomenon is more noticeable particularly when a query is a search example data such as video, etc., instead of a keyword. Therefore, according to another exemplary embodiment of the present invention, it is possible to adaptively select the range or the number of data or individual data for analysis or learning on the basis of a primary search result. Further, on the basis of this, it is possible to adaptively select the analysis/learning method.

An example of recognizable pattern of similarity values is as follows. For the first example, a first rank similarity value of a case where a relevant data is ranked first in a search result list is generally larger than a first rank similarity value of a case where a non-relevant data is ranked first in a search result list. For the second example, a difference between the first rank similarity value and a second rank similarity value of the case where a relevant data is ranked first in a search result list is generally larger than a difference between the first rank similarity value and a second rank similarity value of the case where a non-relevant data is ranked first in a search result list. In general, the pattern of the second example is more apparent than the first example.

Therefore, in order to include relevant data in the training data, the performing unit 400 may select a larger amount of data sequentially from the first rank to a lower rank as the training data when the similarity score of the first rank is lower than reference similarity, as compared to the case where the similarity score of the first rank is higher than the reference similarity. That is, the performing unit 400 may select a larger amount of data from the first rank to a low rank as the first rank similarity value becomes smaller, and select a smaller amount of data from the first rank to a low rank as the first rank similarity value becomes bigger.

Alternatively, the performing unit 400 may select a larger amount of data sequentially from the first rank to a lower rank as the training data when the difference in the degree of correspondence between the first rank and the second rank is smaller than a reference similarity difference, as compared to the case where the difference in the degree of correspondence is larger than the reference similarity difference. That is, the performing unit 400 may select a larger amount of data sequentially from the first rank to a lower rank as the difference between the first rank similarity value and the second rank similarity value becomes smaller, and select a smaller amount of data from the first rank to a lower rank as the difference between the first rank similarity value and the second rank similarity value becomes bigger.

Next, the second search unit 500 modifies the search result of the first search unit 200 by using a result of the machine learning (S140) and outputs a multimedia search result. For example, the second search unit 500 may re-rank the search result of the first search unit 200 by using the result of the machine learning. Alternatively, the second search unit 500 may re-rank only the data selected as the training data to reduce a user's waiting time.

Although the above example applies analysis/learning once after primary search of the first search unit 200 has been described above, after the primary search, depending on the range and amount of the data selected for analysis or learning and the analysis/learning method, analysis/learning may be performed in stages or repeatedly.

For example, after selecting a relatively large amount of data from the primary multimedia data search result of the first search unit 200, relatively simple and fast analysis/learning method is applied while being expected to have a higher degree of recognition or higher accuracy of search than the method used in the primary multimedia data search. Further, the search result may be re-ranked and then upper data may be selected from the search result. Thereafter, an analysis/learning method which is expected to have good recognition or search performance even when requiring a larger capacity of memory and a larger computational amount than the analysis/learning method used before may be applied.

As another example, in order to prevent data which the user actually wants to search for from the search target data from being excluded from the training data selected in the training data selection step (S120), it is possible to select the data in relatively middle ranks or middle-upper ranks from the primary search result and perform analysis/learning on the selected data. Further, according to the result of the analysis/learning, a part of data which has a high probability of being data which the user wants to search for is selected and used as the analysis/learning data together the upper data. And, in some cases, this may be performed in stages or repeatedly.

As described above, since the multimedia data search method and apparatus according to the exemplary embodiments of the present invention uses the result of the first search unit 200 and the primary search step (S110) corresponding to the existing search system, it is possible to use existing system and method, as they practically are, without any change. Further, since the training data optimized for the search condition data is used, it is possible to improve the search rate or the accuracy of search.

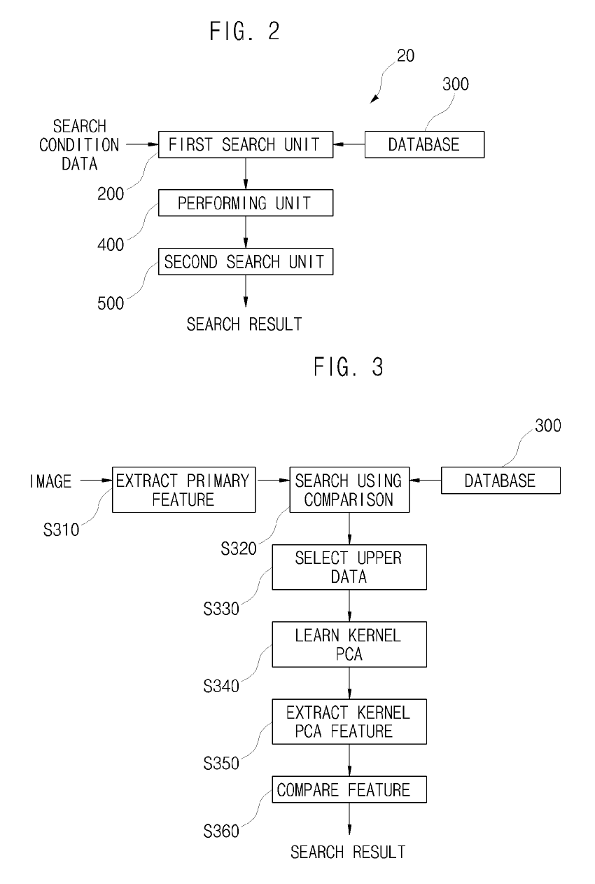

Hereinafter, another exemplary embodiment of the present invention will be described with reference to FIG. 3. FIG. 3 is a conceptual view illustrating another exemplary embodiment of the present invention. In order to describe the spirit or scope of the present invention more specifically, a case in which an image search system searches for images in the database on the basis of an image input as the search condition data will be described as an example. This is for facilitating an understanding of the present invention and the principle of the present invention is not limited to the image search system.

It is assumed that in the image search system, various kinds of images (search target data) and features (hereinafter, referred to as ‘primary search target features) extracted from them are registered/stored in advance in the database 300. And, if the user inputs a query or a test image as the ‘search condition data’, the image search system compares the stored primary search target features and a feature extracted from the image input by the user, makes a list of images in order of the similarity, and returns the list.

Specifically, the image search system extracts a primary feature (hereinafter, referred to as ‘a primary search condition feature’) from the image (S310). For example, the image search system extracts the primary search condition feature from the image by using wavelet transform or DCT (discrete cosine transform, etc. In some cases, the primary search condition feature may be a feature extracted from the original image by using a simpler statistical data analysis or machine learning method like PCA, and may be a feature extracted from the feature extracted by using the wavelet transform or DCT by using a relatively simple statistical analysis or machine learning method like PCA.

Next, the image search system searches for data corresponding to the primary search condition feature in the database 300 by comparing primary search target features extracted from the search target data stored in the database 300 with the primary search condition feature (S320).

In this case, as mentioned above, the image search system may rank the search target data sequentially according to the degrees of correspondence between the primary search target features and the primary search condition feature and output the list of the search target data as the search result.

Next, the image search system selects upper data from the search result as the training data (S330), and learns kernel PCA by using the selected data (S340).

The image search system secondarily extracts kernel PCA features from the first search condition feature and the primary search target features by using the learned kernel PCA (S350). Next, the image search system compares the kernel PCA features secondarily extracted from the primary search target features with the kernel PCA feature secondarily extracted from the primary search condition feature (S360), and re-ranks at least a part of the search target data ranked and output in the step (S320) according to the comparison result. For example, the image search system may re-rank the upper data ranked in the step (S320) according to the comparison result while maintaining the ranks of the remaining data non-selected as the upper data and then return the search result to the user.

As alternative another example, the image search system may learn kernel PCA from an original image before the primary feature extraction, that is, the search result of the step (S320), instead of the primary features of the selected upper data (or the search result of the step (S320)), and directly extract the kernel PCA features from the upper data (or the search result of the step (S320)). Then, the image search system may extract the kernel PCA feature from the primary search condition data by using the learned kernel PCA, compare the kernel PCA features extracted from the upper data (or the search result of the step (S320)) with the kernel PCA feature extracted from the primary search condition data, and re-rank at least a part of the search target data according to the comparison result.

Meanwhile, the PCA (principal component analysis) used as the secondary feature extracting method will be described. In general, the kernel PCA which is extended PCA can extract better features and have higher accuracy in recognition and search as compared to the PCA. The PCA generates a basis vector for feature extraction as the learning result. The secondary features are extracted by projecting the primary features onto the basis vector. The Kernel PCA also generates a basis vector for feature extraction from the training data like the PCA. However, the kernel PCA requires a larger computational amount and a larger capacity of memory as compared to the PCA. In particular, unlike the PCA, in order to generate the basis vector, the kernel PCA should have all the individual learning data after completing the learning. Therefore, the kernel PCA takes a larger amount of time to extract the features than the PCA and has many limits in practical application in the case in which an amount of training data is large.

Another difference is as follows. The PCA uses a matrix in which each of the number of rows and the number of columns is the dimension of the primary features for data analysis. For example, if the dimension of the primary features is 100, a matrix whose dimensions 100×100 is used. Alternatively, a matrix in which the number of rows and the number of columns is the number of training data may be used. Therefore, it is possible to adaptively use a computation method in consideration of the dimension of the primary features and the number of training data. However, the kernel PCA uses only a matrix in which the number of rows and the number of columns are the number of training data for data analysis. In the case of multimedia data, the multimedia data is high dimensional data but the number of data to be practically searched for far exceeds the dimension of the data. Therefore, even though the kernel PCA exhibits the higher accuracy than the PCA, it is practically difficult to use the kernel PCA than the PCA.

In order to resolve this, in the exemplary embodiments of the present invention, the kernel PCA is used for the secondary feature extraction. Therefore, it is possible to effectively perform search while improving the accuracy of search. Further, as described above, even in this exemplary embodiment, since the result of the primary search step (S110) corresponding to the existing search method is used, it is possible to use existing system and method, as they practically are, without any change. Further, if using the upper data which is a part of the search target data, it is possible to expect the high accuracy of search or a high recognition rate with a relatively small amount of computation and a small capacity of memory.

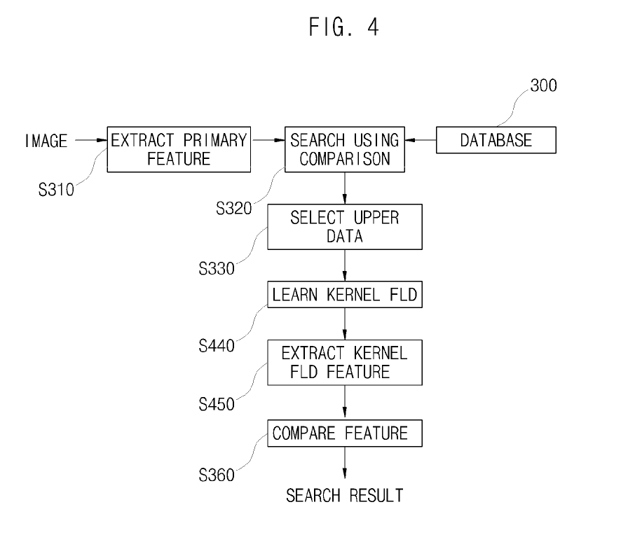

The example shown in FIG. 3 relates to the search method using the kernel PCA; however, it is also applicable to a search method using a different feature extracting method in the same manner. For example, as shown in FIG. 4, kernel FLD (fisher linear discriminator) may be used.

The PCA is unsupervised learning, and FLD is supervised learning. It is known that the FLD is generally better in the recognition and search performance than the PCA. Further, as if the kernel PCA is the extended PCA, the kernel FLD is improved FLD. It is known that the kernel FLD is more superior in recognition and search than the FLD. However, because of the same problems as those of the kernel PCA, it is more difficult to apply the kernel FLD with respect to a large amount of data, as compared to the FLD.

For this reason, in another exemplary embodiment of the present invention, features are secondarily extracted by using the kernel FLD. FIG. 4 is a conceptual view illustrating multimedia search method and apparatus according to another exemplary embodiment of the present invention. A detailed description of the steps of performing the same functions as those of the steps shown in FIG. 3 is omitted.

Referring to FIG. 4, unlike the previous exemplary embodiments, an image search system performs learning by using the kernel FLD (S440), secondarily extracts kernel FLD features from the primary search condition feature and the primary search target features (S450), and achieves the multimedia search result.

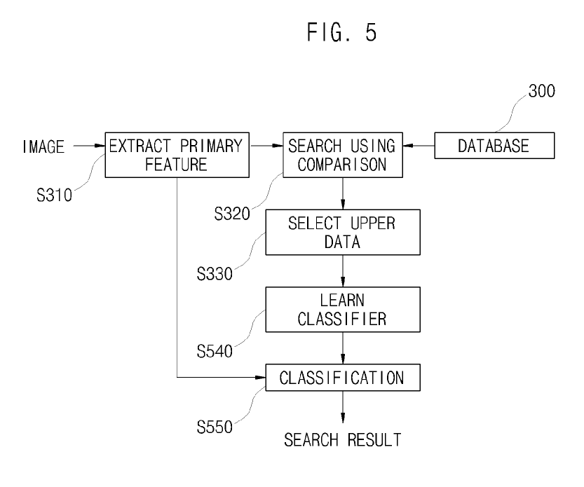

Meanwhile, referring to FIG. 5, multimedia search method and apparatus according to another exemplary embodiment of the present invention will be described. FIG. 5 is a conceptual view illustrating multimedia search method and apparatus according to another exemplary embodiment of the present invention. A detailed description of the steps of performing the same functions as those of the steps shown in FIG. 3 is omitted.

An image search system according to this exemplary embodiment selects the upper data from the search result of the step (S320) as the training data (S330), and learns a classifier by using the selected data. The classifier may be composed of one or more. Examples of representative classifiers include a SVM (support vector machine). It is known that the SVM exhibits superior classification performance but is difficult to perform learning with respect of a large amount of data. However, in the case of using the exemplary embodiment of the present invention, since a class boundary is formed or a small number of data having high probabilities of being in the vicinity of the class boundary are selected and used, it is possible to easily perform learning. Which class (or person) to which the feature extracted from the image input by the user belongs is determined by using the learned classifier (S550). The classification result value of the classifier may represent the confidence regarding the search condition data belongs to which class. Even in the other cases, the classification result value can be easily converted into the confidence regarding the search condition data belongs to which class.

The image search system re-ranks the upper data selected previously by using the classification result value of the classifier while maintaining the ranks of the remaining data non-selected as the upper data, and returns the search result to the user.

In the case of the above example, the cases in which the feature extraction and classifier are respectively used have been described. However, it can also be easily applied to the case of using the feature extraction and the classifier based on the statistical data analysis or machine learning together.

According to the exemplary embodiments of the present invention, since the training data optimized for the test data is used as actual training data, it is possible to expect high performance in recognition, classification, etc., and to effectively apply machine learning to a large amount of data.

Further, in the case of applying the exemplary embodiment of the present invention to a method or apparatus for searching for a large amount of multimedia data, it is possible to effectively improve the accuracy of search while maintaining or minimizing a method or apparatus for searching a large amount of data established in advance. Specifically, the exemplary embodiments of the present invention have the following advantages.

First, since the exemplary embodiments of the present invention use the final results of an existing search system or search method, it is possible to apply the spirit or scope of the present invention while maintaining or minimizing the system or used method established in advance.

Second, since the training data optimized for search data/query/test data is selected, it is possible to improve a search rate or the accuracy of search.

Third, since it is possible to adaptively select the range or amount of training data according to search data/query/test data, it is possible to minimize additionally required process time with respect to the existing search system or search method.

Fourth, since instead of the entire search target data, some data is effectively selected as the training data, it is possible to easily apply an analysis method, which is expected to have a high degree of accuracy of search or a high recognition rate, but is difficult to be applied because requiring a large computational amount or a high-capacity memory.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A multimedia data search method comprising:
searching for data corresponding to search condition data input by a user in search target data;
selecting training data for machine learning on the basis of the search result;
performing machine learning by using the selected training data; and
modifying the search result by using the result of the machine learning.

2. The method of claim 1, wherein:
the searching includes ranking the search target data sequentially according to degrees of correspondence with the search condition data.

3. The method of claim 2, wherein:
the selecting includes selecting a subset of the ranked search target data as the training data sequentially from a first rank to lower ranks.

4. The method of claim 2, wherein:
the selecting includes selecting a smaller amount of data from a first rank to lower ranks as the training data when the degree of correspondence of a first rank data of the ranked search target data is equal to or higher than a reference similarity, as compared to when the degree of correspondence is lower than the reference similarity.

5. The method of claim 2, wherein:
the selecting includes selecting a smaller amount of data from the first rank to lower ranks as the training data when a difference in the degree of correspondence between a first rank data and a second rank data of the ranked search target data is equal to or greater than a reference similarity difference, as compared to when the difference in the degree of correspondence is less than the reference similarity difference.

6. The method of claim 2, wherein:
the modifying includes re-ranking the ranked search target data by using the result of the machine learning.

7. A multimedia data search apparatus comprising:
a database storing search target data and primary search target features extracted from the search target data;
a first search unit extracting primary search condition feature from search condition data input by a user and searching for data corresponding to the primary search condition feature in the database by comparing the primary search target features with the primary search condition feature;
a performing unit selecting training data for machine learning on the basis of the search result and performing machine learning by using the selected training data; and
a second search unit modifying the search result by using the result of the machine learning.

8. The apparatus of claim 7, wherein:
the first search unit ranks the search target data sequentially according to degrees of correspondence between the primary search condition feature and the primary search target features.

9. The apparatus of claim 8, wherein:
the performing unit selects a subset of the ranked search target data as the training data sequentially from a first rank to lower ranks.

10. The apparatus of claim 8, wherein:
the second search unit
extracts secondary features from the primary search condition feature and the primary search target features by using the result of the machine learning, respectively, and
compares the secondarily extracted features and re-ranks at least a part of the ranked search target data according to the comparison result.

11. The apparatus of claim 8, wherein:
the second search unit
extracts secondary features from the search condition data and at least a part of the search target data by using the result of the machine learning, respectively, and
compares the secondarily extracted features and re-ranks the at least a part of the ranked search target data according to the comparison result.

12. The apparatus of claim 8, wherein:
the second search unit classifies the primary search condition feature, and re-ranks at least a part of the search target data on the basis of the classified result.

13. The apparatus of claim 12, wherein:
the second search unit uses SVM (support vector machine).

14. The apparatus of claim 8, wherein:
the performing unit selects a smaller amount of data from a first rank to lower ranks as the training data when the degree of correspondence of a first rank data of the ranked search target data is equal to or higher than a reference similarity, as compared to when the degree of correspondence is lower than the reference similarity.

15. The apparatus of claim 8, wherein:
the performing unit selects a smaller amount of data from a first rank to lower ranks as the training data when a difference in the degree of correspondence between a first rank data and a second rank data of the ranked search target data is equal to or greater than a reference similarity difference, as compared to when the difference in the degree of correspondence is less than the reference similarity difference.

16. The apparatus of claim 7, wherein:
the performing unit performs learning by at least one of PCA (principal component analysis), kernel PCA, FLD (fisher linear discriminator), and kernel FLD.

17. A pattern recognition method comprising:
selecting a subset of training data on the basis of test data;
performing machine learning by using the selected training data; and
applying the result of the machine learning to the test data.

18. The method of claim 17, wherein:
in the selecting, data capable of approximating the test data, or data capable of predict a class of the test data, or data being in a predetermined range from a statistical property of the test data is selected as the training data.
